(19) United States
(12) Patent Application Publication
(10) Pub. No.: US 2026/0111795 A1
(43) Pub. Date: Apr. 23, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Yoshiki TAKAHASHI, Tokyo (JP); Kosuke JITSUHARA, Tokyo (JP); Kazuki TSUCHIYA, Tokyo (JP); Shota EJIMA, Tokyo (JP); Yuki YANAGIDA, Tokyo (JP); Hitoshi ABE, Tokyo (JP); Masato SUZUKI, Tokyo (JP)

(21) Appl. No.: 19/287,541

(22) Filed: Jul. 31, 2025

(30) Foreign Application Priority Data
Oct. 18, 2024 (JP) 2024-182620

(51) Int. Cl. G06N 20/00

(52) U.S. Cl. CPC G06N 20/00

(57) ABSTRACT

An information processing apparatus according to the present application includes: a PB estimation model training unit configured to determine data regarding private browsing based on a click log of a delivered advertisement to generate training data and configured to train, with the training data, a PB missing CV estimation model of estimating a conversion that is missing without being measured by private browsing; a PB missing CV estimation unit configured to estimate, using the PB missing CV estimation model, the conversion that is missing without being measured by private browsing; and an output processing unit configured to make a report or improvement regarding the delivered advertisement based on the missing conversion estimated by the PB missing CV estimation model.

### CROSS-REFERENCE TO RELATED APPLICATIONS

The present application claims priority to and incorporates by reference the entire contents of Japanese Patent Application No. 2024-182620 filed in Japan on Oct. 18, 2024.

### BACKGROUND OF THE INVENTION

### 1. Field of the Invention

The present invention relates to an information processing apparatus, an information processing method, and an information processing program.

### 2. Description of the Related Art

A technique of estimating missing data regarding conversion (CV) measurement has been disclosed (refer to JP 2023-170222 A).

However, in the above-described technique of the related art, missing data regarding the conversion measurement has been appropriately estimated. In a status where missing occurs in conversion measurement of a specific browser with a predetermined version or higher, there is room for improvement regarding a method of estimating and complementing the CV.

### SUMMARY OF THE INVENTION

According to an aspect, an information processing apparatus includes: a PB estimation model training unit configured to determine data regarding private browsing based on a click log of a delivered advertisement to generate training data and configured to train, with the training data, a PB missing CV estimation model of estimating a conversion that is missing without being measured by private browsing; a PB missing CV estimation unit configured to estimate, using the PB missing CV estimation model, the conversion that is missing without being measured by private browsing; and an output processing unit configured to make a report or improvement regarding the delivered advertisement based on the missing conversion estimated by the PB missing CV estimation model.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the summary of an information processing system according to an embodiment;

FIG. 2 is a diagram illustrating the summary of a conversion measurement complement function;

FIG. 3 is a diagram illustrating a configuration example of a terminal apparatus according to the embodiment;

FIG. 4 is a diagram illustrating a configuration example of a server apparatus according to the embodiment;

FIG. 5 is a flowchart illustrating a procedure according to the embodiment; and

FIG. 6 is a diagram illustrating an example of a hardware configuration.

### DETAILED DESCRIPTION OF THE PREFERRED EMBODIMENTS

Hereinafter, an embodiment for implementing (hereinafter, referred to as “embodiment”) an information processing apparatus, an information processing method, and an information processing program according to the present application will be described in detail with reference to the drawings. The information processing apparatus, the information processing method, and the information processing program according to the present application are not limited to this embodiment. In addition, in the following embodiment, the same components are represented by the same reference numerals, and the repeated description will be omitted.

### 1. Summary of Information Processing System

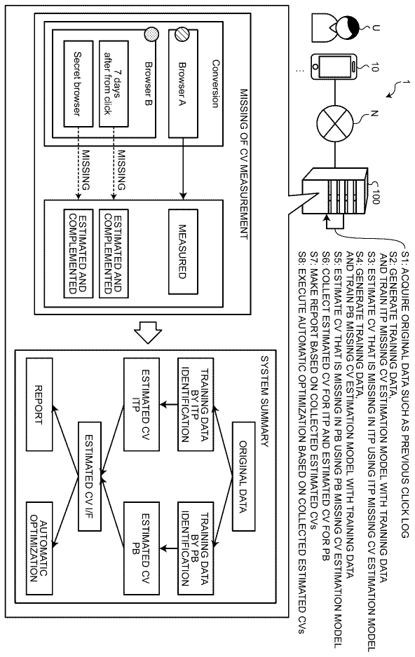

First, the summary of the information processing system according to the embodiment will be described with reference to FIG. 1. FIG. 1 is a diagram illustrating the summary of the information processing system according to the embodiment. As illustrated in FIG. 1, an information processing system 1 according to the embodiment includes a terminal apparatus 10 and a server apparatus 100. The terminal apparatus 10 and the server apparatus 100 are communicably connected through the network N in a wired or wireless manner. As a result, the terminal apparatus 10 can cooperate with the server apparatus 100. The network N is, for example, a LAN (Local Area Network), a WAN (Wide Area Network), or the Internet.

The terminal apparatus 10 is an information processing apparatus used by a user U. For example, the terminal apparatus 10 is a smart device such as a smartphone or a tablet terminal, a PC (Personal Computer) such as a desktop or laptop computer, a mobile phone such as a feature phone (flip phone), a PDA (Personal Digital Assistant), a game machine or AV equipment having a communication function, an information appliance or digital appliance, a car navigation system, or a wearable device such as a smartwatch, a head-mounted display (HDD), or smart glasses. In addition, the terminal apparatus 10 may be a residence or building, a vehicle, an electric appliance, electronic equipment, or the like that supports IOT (Internet of Things).

In the present embodiment, the terminal apparatus 10 is a smart device such as a smartphone or a tablet terminal that is used by the user U, and is a portable terminal apparatus that can communicate with any server apparatus through a wireless communication network such as LTE (Long Term Evolution), 4G (4th Generation), or 5G (5th Generation Communication System), Bluetooth (registered trademark), or a wireless LAN. In addition, the terminal apparatus 10 includes a screen that is a screen such as a liquid crystal display and has a function of a touch panel, and receives various operations on display data such as a content, for example, receives a tap operation, a slide operation, or a scroll operation from the user U through a finger, a stylus, or the like. An operation that is executed on an area where a content is displayed on the screen may be considered the operation on the content. In addition, the terminal apparatus 10 may be a smart device or may be an information processing apparatus such as a desktop PC or a laptop PC.

The server apparatus 100 is, for example, a computer such as a PC or a blade server or a mainframe or workstation. The server apparatus 100 may be implemented by cloud computing.

In the present embodiment, the server apparatus 100 is an information processing apparatus that provides API (Application Programming Interface) services and the like on various applications (hereinafter, applications) and the like and various data to the terminal apparatus 10 of each of the users U in cooperation with the terminal apparatus 10 of each of the users U, and is implemented by a computer, a cloud system, or the like.

In addition, the server apparatus 100 may be an information processing apparatus that provides any online service to the terminal apparatus 10 of each of the users U. For example, the server apparatus 100 may provide, as the online service, a service such as Internet connection, a search service, an advertisement delivery service, a chat service, an interaction service using a voice, an image, or a video, Social Networking Service (SNS), electronic commerce (EC), electronic payment, online game, online banking, online trading, hotel and ticket reservation, video and music delivery, news, map, route search, route guidance, line information, traveling information, or weather forecast. Actually, the server apparatus 100 may mediate the online service or may handle the processing of the online service in cooperation with various servers that provide the above-described online service.

The server apparatus 100 can acquire user information regarding the user U. For example, the server apparatus 100 may acquire, as the user information, information (attribute information) regarding attributes of the user U, for example, a gender, an age, a place of residence of the user U. In addition, the server apparatus 100 can acquire information regarding the attributes of the user U, for example, a demographic attribute, a psychographic attribute, a geographic attribute, and a behavioral attribute. In addition, the server apparatus 100 may acquire, as the user information, a segment or a persona belonging to the user U in the marketing field. The server apparatus 100 stores and manages not only identification information (such as a user ID) representing the user U but also the information (attribute information) regarding the attributes of the user U.

In addition, the server apparatus 100 acquires various history information (log data) representing a behavior of the user U from the terminal apparatus 10 of the user U or from various servers or the like based on the user ID or the like. For example, the server apparatus 100 acquires position history that is history of a position or date and time of the user U from the terminal apparatus 10. In addition, the server apparatus 100 acquires search history that is a history of a search query input from the user U from a search server (search engine). In addition, the server apparatus 100 acquires browsing history that is history of contents browsed by the user U from a content server. In addition, the server apparatus 100 acquires purchase history (payment history) that is history of commodity purchase or payment processing of the user U from an electronic commerce server or a payment processing server. In addition, the server apparatus 100 may acquire offering history or sales history that is history of offering items on a marketplace of the user U from the electronic commerce server or the payment processing server. The server apparatus 100 acquires posting history of the user U from a posting server or an SNS server that provides a word-of-mouth posting service. The above-described various servers or the like may be the server apparatus 100 itself. That is, the server apparatus 100 may function as the above-described various servers or the like.

In addition, the number of the apparatuses in the information processing system 1 illustrated in FIG. 1 is not limited to that illustrated in the drawing. For example, FIG. 1 illustrates only one terminal apparatus 10 to simplify the drawing. This configuration is merely exemplary, and the present invention is not limited thereto. However, the number of the terminal apparatuses 10 may be two or more.

### 2. Estimated CV Extension Function for Private Browsing

### 2-1. Conversion Measurement Complement Function

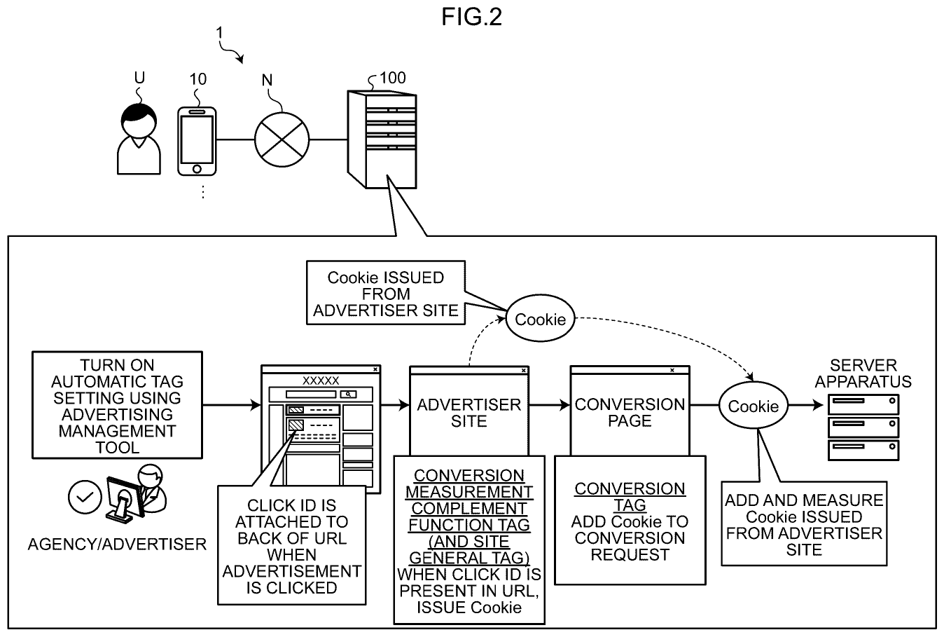

Referring to FIG. 2, a conversion measurement complement function will be described. FIG. 2 is a diagram illustrating the summary of the conversion measurement complement function. In the present embodiment, the server apparatus 100 controls delivery of a web advertisement. An advertiser server as a server apparatus that operates an advertiser site of an advertiser will be described together with the server apparatus 100, and thus the description and illustration will not be made. Actually, the advertiser server and the server apparatus 100 are present independent of each other.

Not only the effect of ITP (Intelligent Tracking Prevention: tracking prevention function) but also the limitation of a third party cookie in each browser causes a large effect on measurement of advertising effectiveness. Therefore, as the conversion (CV) measurement complement function in the web advertising service, the server apparatus 100 provides some functions (for example, automatic tag setting, a site general tag, or a conversion (CV) measurement complement function). The third party cookie is a cookie issued from a domain other than a site visited by a user. The cookie is a small data file for temporarily storing information of a user who is accessing a website or web server in a browser.

As shown in FIG. 2, turning on the automatic tag setting by an agency/advertiser with an advertising management tool enables a click ID of an advertisement to be attached to the back of an URL (Uniform Resource Locator) when the advertisement is clicked. “Site general tag” and “conversion (CV) measurement complement function tag” are installed in all the pages in the website of the advertiser. By installing this tag in all the pages, at the time of transition from the advertisement to which the click ID of the advertisement is attached, the information thereof is stored in the cookie of the advertiser site. And then, at the time of generation of a conversion (CV), it becomes possible for the information thereof to be transmitted to the server apparatus 100.

### 2-2. Estimated CV Extension Function for Private Browsing

However, in a specific browser, privacy is enhanced by private browsing (PB) after a predetermined version or higher, the conversion (CV) measurement complement function does not function, and missing occurs in the conversion (CV) measurement. Therefore, the missing CV needs to be estimated and complemented. The private browsing is a browser function in which browsing information such as browsing history, a cookie, site data, or login information during browsing is not stored and tracking is prevented after the session ends. The private browsing is also called a secret mode.

The reason for the missing is that a link decoration for tracking is deleted and then the click ID of the advertisement becomes less able to be acquired. The link decoration is a method of adding information to an URL, in which when the URL is clicked, the information is delivered to a site of a link destination. Specifically, a portion displayed after the symbol “?” added to the URL is additional information. This additional information is called a query string. The query string is also configured by collecting a plurality of individual information called query parameters. The query parameters are divided by the symbol “&” and have the same format, in which, for example, as in “label=information”, the label of the information, the symbol “=”, and the information itself are described in this order. The click ID of the advertisement is an identifier that is assigned instead of the third party cookie for the conversion (CV) measurement when the user clicks the advertisement.

Accordingly, in the present embodiment, a framework and an interface (I/F) of an estimated CV for ITP are extended, and the estimated CV for the private browsing (PB) mode is provided for newly making a report or for automatic optimization.

For example, as illustrated in FIG. 1, the server apparatus 100 divides original data such as a previous click log into training data by ITP identification and training data by PB identification, trains separate models with the training data, respectively, as a job of training, and estimates a CV using each of the models as a job of inference. At this time, the server apparatus 100 trains an ITP missing CV estimation model with the training data by ITP identification, and calculates and outputs an estimated CV for ITP using the ITP missing CV estimation model. In addition, the server apparatus 100 trains a PB missing CV estimation model with the training data by PB identification, and calculates and outputs an estimated CV for PB using the PB missing CV estimation model. The server apparatus 100 makes a report of a delivered advertisement or executes automatic optimization of the delivery control based on the estimated CVs through the interface (I/F) that receives the estimated CVs. When the estimated CV for ITP and the estimated CV for PB overlap each other, the server apparatus 100 overwrites the estimated CV for ITP with the estimated CV for PB in the interface (I/F).

The job of inference is daily executed as batch inference. Specifically, the server apparatus 100 executes batch inference on the number of CVs generated on the job execution date associated with the previous click log, and associates the result with each of components through a database.

Here, the reason why the model of the estimated CV for ITP and the model of the estimated CV for PB are separated is that problem settings differ between ITP and PB. It is assumed that a CV is missing 8 days after click in ITP and a CV is missing on the day of click in PB. Therefore, the separate models are constructed and operated such that: a model of predicting a CV of the eighth day or thereafter where a CV measurement amount or the like for 7 days after click is added to a feature amount is constructed for ITP; and a model of predicting a CV of the first day where a feature amount does not include a CV measurement amount or the like is constructed for PB.

In the example of FIG. 1, the server apparatus 100 acquires original data such as a previous click log (Step S1). For example, the server apparatus 100 accesses a database where click logs are collected and stored, refers to the previous click log or the like, and uses the previous click log or the like as the original data.

Next, the server apparatus 100 extracts whether or not a click and a CV relating to ITP are present from the original data such as the previous click log to generate training data by ITP identification, and trains the ITP missing CV estimation model with this training data (Step S2).

Next, the server apparatus 100 inputs the click relating to ITP to the ITP missing CV estimation model, and estimates a CV that is missing in ITP (Step S3). That is, the server apparatus 100 causes the ITP missing CV estimation model to output the estimated CV for ITP. This process may be executed through batch processing.

Next, the server apparatus 100 estimates whether or not a click and a CV relating to PB are present based on the original data such as the previous click log to generate training data by PB identification, and trains the PB missing CV estimation model with this training data (Step S4).

Next, the server apparatus 100 inputs the click relating to PB to the PB missing CV estimation model, and estimates a CV that is missing in PB (Step S5). That is, the server apparatus 100 causes the PB missing CV estimation model to output the estimated CV for PB. This process may be executed through batch processing.

Next, the server apparatus 100 collects the estimated CV for ITP and the estimated CV for PB through the interface (I/F) that receives the estimated CVs (Step S6).

Next, the server apparatus 100 makes a report based on the collected estimated CVs, and provides the generated report to an agency/advertiser (Step S7). In this report, a proposal on the content of an advertisement, settings of delivery, or the like may be made to the agency/advertiser.

In addition, the server apparatus 100 executes automatic optimization of the delivered advertisement based on the collected estimated CVs (Step S8). That is, the server apparatus 100 automatically executes a delivery control of an advertisement, a change in settings, or the like based on the collected estimated CVs.

### 2-3. Private Browsing Determination

Whether or not private browsing (PB) is used cannot be identified (unidentifiable) from the log. Therefore, approximation determination of PB is made in a limited delivery section of the own company. For example, when an elapsed time after issuing a cookie from the own company to the user is within a fixed threshold, the server apparatus 100 approximately determines that PB is used. In the present embodiment, the threshold is conservatively set to “1 hour”. Actually, the threshold is freely set. Note that the determination may also be false-positive/false-negative. In addition, the delivery section of the own company is merely an example. Actually, the determination target is not limited to the own company and may be a specific domain or the like that is a CV measurement target, for example, a client company that is a service providing target of the own company and from which a click log of a user can be acquired as the own company. In addition, the determination target is not limited to the delivery section, and may be a specific web delivery medium, a specific website or web page (landing page (LP)), a specific application, a specific thumbnail, a specific content or the like.

### 2-4. Alternative of User Information

In the present embodiment, private browsing (PB) is an estimation target, therefore it may be difficult to utilize the user information at the time of estimating the user information. In this case, the estimation model may internally execute estimation utilizing account information of the advertiser or advertisement information.

The server apparatus 100 may implement the above-described mechanism with an AI (Artificial Intelligence) such as GPT (Generative Pre-trained Transformer). The GPT is a text-generating AI and is a language model capable of generating a text using natural language processing.

### 2-5. Expected Effect

### (1) Amount of Increase of Estimated CV

When the extension function according to the present embodiment is used, the estimated CV transitions to an increase of about 10% to 12% per day in a measurement period as compared to when the extension function is not used.

### (2) Delivery Enhancement for Estimation Target

By enhancing the distribution for the estimation target, delivery of a new estimation target is promoted, the number of clicks in the new estimation target is increased by 20.9% in an online test.

### 3. Configuration Example of Terminal Apparatus

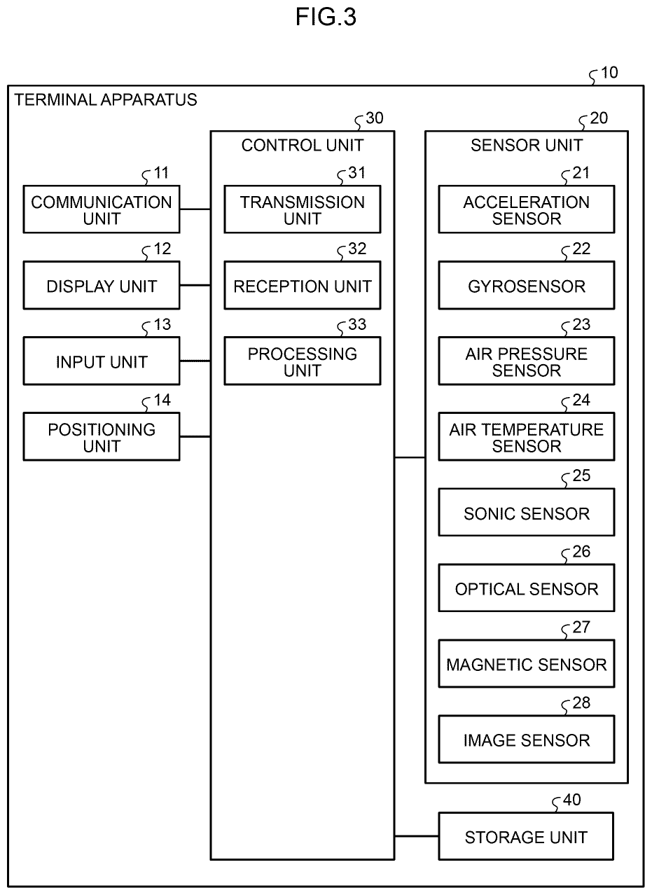

Next, a configuration of the terminal apparatus 10 will be described using FIG. 3. FIG. 3 is a diagram illustrating a configuration example of the terminal apparatus 10 according to the embodiment. As illustrated in FIG. 3, the terminal apparatus 10 includes a communication unit 11, a display unit 12, an input unit 13, a positioning unit 14, a sensor unit 20, a control unit 30 (controller), and a storage unit 40.

### Communication Unit 11

The communication unit 11 is connected to the network N in a wired or wireless manner, and transmits and receives information to and from the server apparatus 100 through the network N. For example, the communication unit 11 is implemented by a NIC (Network Interface Card), an antenna, or the like.

### Display Unit 12

The display unit 12 is a display device that displays various information such as positional information. For example, the display unit 12 is a liquid crystal display (LCD) or an organic EL display (Organic Electro-Luminescent Display). In addition, the display unit 12 is a touch panel type display but is not limited thereto.

### Input Unit 13

The input unit 13 is an input device that receives various operations from the user U. For example, the input unit 13 includes buttons for inputting characters, numbers, and the like. The input unit 13 may be an input/output port (I/O port), a USB (Universal Serial Bus) port, or the like. In addition, when the display unit 12 is a touch panel type display, a part of the display unit 12 functions as the input unit 13. In addition, the input unit 13 may be a microphone or the like that receives an audio input from the user U. The microphone may be wireless.

### Positioning Unit 14

The positioning unit 14 receives a signal (radio wave) transmitted from a GPS (Global Positioning System) satellite, and acquires positional information (for example, a latitude and a longitude) representing the current position of the terminal apparatus 10 that is the own apparatus based on the received signal. That is, the positioning unit 14 measures the position of the terminal apparatus 10. The GPS is merely an example of GNSS (Global Navigation Satellite System).

In addition, the positioning unit 14 can measure the position using various methods other than GPS. For example, the positioning unit 14 may measure the position using various communication functions of the terminal apparatus 10 as described below as auxiliary positioning units for position correction or the like.

### Wi-Fi Positioning

For example, the positioning unit 14 measures the position of the terminal apparatus 10 using a Wi-Fi (registered trademark) communication function of the terminal apparatus 10 or using a communication network in each communication company. Specifically, the positioning unit 14 measures the position of the terminal apparatus 10 by executing the Wi-Fi communication or the like and measuring the distance to a neighboring base station or access point.

### Beacon Positioning

In addition, the positioning unit 14 may measure the position using a Bluetooth (registered trademark) function of the terminal apparatus 10. For example, the positioning unit 14 measures the position of the terminal apparatus 10 by being connected to a beacon transmitter through the Bluetooth (registered trademark) function.

### Geomagnetic Positioning

In addition, the positioning unit 14 measures the position of the terminal apparatus 10 based on a geomagnetic pattern of a structure that is measured in advance and a geomagnetic sensor in the terminal apparatus 10.

### RFID Positioning

In addition, for example, when the terminal apparatus 10 has a function of the same RFID (Radio Frequency Identification) tag as a contactless IC card of a station ticket gate, a store, or the like or has a function of reading an RFID tag, the terminal apparatus 10 records information regarding execution of payment or the like by the terminal apparatus 10 and a position where the terminal apparatus 10 is used. The positioning unit 14 may measure the position of the terminal apparatus 10 by acquiring the information. In addition, the position may be measured using an optical sensor, an infrared sensor, or the like in the terminal apparatus 10.

The positioning unit 14 may measure the position of the terminal apparatus 10 optionally using one or a combination of the above-described positioning units.

### Sensor Unit 20

The sensor unit 20 includes various sensors mounted on or connected to the terminal apparatus 10. The connection may be wired connection or wireless connection. For example, the sensors may be a detection apparatus other than the terminal apparatus 10, for example, a wearable device or a wireless device. In the example illustrated in FIG. 3, the sensor unit 20 includes an acceleration sensor 21, a gyrosensor 22, an air pressure sensor 23, an air temperature sensor 24, a sonic sensor 25, an optical sensor 26, a magnetic sensor 27, and an image sensor (camera) 28.

Each of the sensors 21 to 28 is merely exemplary and is not limited. That is, the sensor unit 20 may be configured to include some of the sensors 21 to 28, or may include other sensors such as a humidity sensor in addition to or instead of the sensors 21 to 28.

The acceleration sensor 21 is, for example, a three-axis acceleration sensor, and detects physical movements of the terminal apparatus 10 such as a movement direction, a speed, and an acceleration of the terminal apparatus 10. The gyrosensor 22 detects a physical movement of the terminal apparatus 10 such as an inclination of a three-axis direction based on an angular speed of the terminal apparatus 10. The air pressure sensor 23 detects, for example, an ambient pressure of the terminal apparatus 10.

The terminal apparatus 10 includes the acceleration sensor 21, the gyrosensor 22, the air pressure sensor 23, and the like. Therefore, the position of the terminal apparatus 10 can be measured with a technique such as pedestrian dead-reckoning (PDR) using each of these sensors 21 to 23 and the like. As a result, indoor positional information that is difficult to acquire with a positioning system such as GPS can be acquired.

For example, the number of steps, a walking speed, a walking distance can be calculated by a pedometer using the acceleration sensor 21. In addition, a traveling direction, a gaze direction, and a body tilt of the user U can be learned using the gyrosensor 22. In addition, a height or a floor number where the terminal apparatus 10 of the user U is present can also be learned from an air pressure detected by the air pressure sensor 23.

The air temperature sensor 24 detects, for example, an ambient temperature of the terminal apparatus 10. The sonic sensor 25 detects, for example, an ambient sound of the terminal apparatus 10. The optical sensor 26 detects, for example, an ambient illuminance of the terminal apparatus 10. The magnetic sensor 27 detects, for example, an ambient geomagnetism of the terminal apparatus 10. The image sensor 28 acquires, for example, an ambient image of the terminal apparatus 10.

The air pressure sensor 23, the air temperature sensor 24, the sonic sensor 25, the optical sensor 26, and the image sensor 28 can detect an ambient environment or status or the like of the terminal apparatus 10 by detecting the air pressure, the air temperature, the sound, and the illuminance or imaging the ambient image. In addition, the accuracy of the positional information of the terminal apparatus 10 can be improved from the ambient environment or status of the terminal apparatus 10.

### Control Unit 30

The control unit 30 includes, for example, a microcomputer including a CPU (Central Processing Unit) or MPU (Micro Processing Unit), a ROM (Read Only Memory), a RAM, an input/output port, and the like or various circuits. In addition, the control unit 30 may be configured with, for example, hardware of an integrated circuit such as ASIC (Application Specific Integrated Circuit) or FPGA (Field Programmable Gate Array). The control unit 30 includes a transmission unit 31, a reception unit 32, and a processing unit 33.

### Transmission Unit 31

The transmission unit 31 can transmit, for example, various information input from the user U using the input unit 13, various information detected by the sensors 21 to 28 mounted on or connected to the terminal apparatus 10, or the positional information of the terminal apparatus 10 measured by the positioning unit 14 to the server apparatus 100 through the communication unit 11.

### Reception Unit 32

The reception unit 32 can receive various information provided from the server apparatus 100 or request of various information from the server apparatus 100 through the communication unit 11.

### Processing Unit 33

The processing unit 33 includes the display unit 12 and controls the entire terminal apparatus 10. For example, the processing unit 33 can output and display various information transmitted by the transmission unit 31 or various information from the server apparatus 100 received by the reception unit 32 to and on the display unit 12.

### Storage Unit 40

The storage unit 40 is implemented by, for example, a semiconductor memory element such as a RAM (Random Access Memory) or a flash memory (Flash Memory) or a storage apparatus such as an HDD (Hard Disk Drive), an SSD (Solid State Drive), or an optical disk. Various programs, various data, or the like are stored in the storage unit 40.

### 4. Configuration Example of Server Apparatus

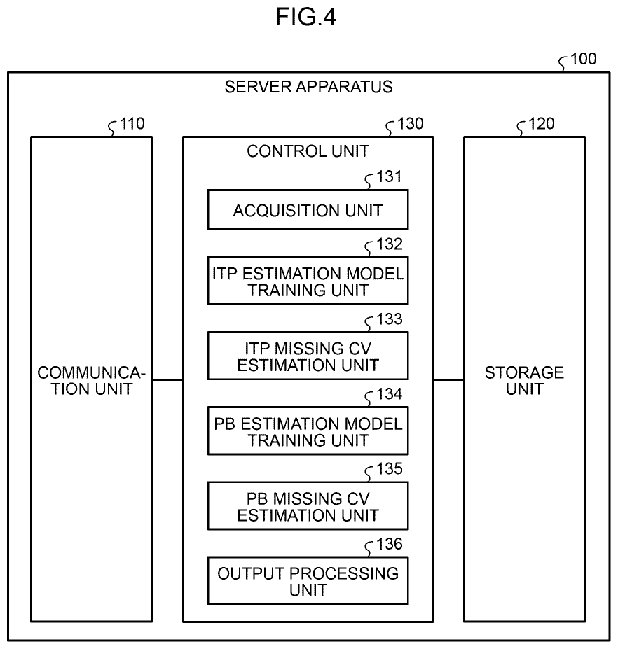

Next, a configuration of the server apparatus 100 according to the embodiment will be described using FIG. 4. FIG. 4 is a diagram illustrating a configuration example of the server apparatus 100 according to the embodiment. As illustrated in FIG. 4, the server apparatus 100 includes a communication unit 110, a storage unit 120, and a control unit 130.

### Communication Unit 110

The communication unit 110 is implemented by, for example, a NIC (Network Interface Card). In addition, the communication unit 110 is connected to the network N in a wired or wireless manner.

### Storage Unit 120

The storage unit 120 is implemented by, for example, a semiconductor memory element such as a RAM (Random Access Memory) or a flash memory (Flash Memory) or a storage apparatus such as an HDD, an SSD, or an optical disk. The storage unit 120 may store not only identification information (such as a user ID) representing the user U but also the attribute information of the user U or the history information (log data).

### Control Unit 130

The control unit 130 is a controller and is implemented, for example, when a CPU (Central Processing Unit), an MPU (Micro Processing Unit), a GPU (Graphics Processing Unit), an ASIC (Application Specific Integrated Circuit), or a FPGA (Field Programmable Gate Array) executes various programs (corresponding to an example of the information processing program) stored in a storage apparatus inside the server apparatus 100 by using a storage area such as a RAM as a work area. In the example illustrated in FIG. 4 the control unit 130 includes an acquisition unit 131, an ITP estimation model training unit 132, an ITP missing CV estimation unit 133, a PB estimation model training unit 134, a PB missing CV estimation unit 135, and an output processing unit 136.

### Acquisition Unit 131

The acquisition unit 131 acquires a search query input from the user U. For example, when the user U inputs a search query to a search engine or the like and executes a keyword search, the acquisition unit 131 acquires the search query through the communication unit 110. That is, the acquisition unit 131 acquires a keyword input to the search engine or a search window of a site or an application by the user U through the communication unit 110.

In addition, the acquisition unit 131 acquires the user information regarding the user U through the communication unit 110. For example, the acquisition unit 131 acquires the identification information (user ID or the like) representing the user U, the positional information of the user U, the attribute information of the user U, and the like from the terminal apparatus 10 of the user U. In addition, the acquisition unit 131 may acquire the identification information representing the user U, the attribute information of the user U, and the like at the time of user registration of the user U. The acquisition unit 131 stores the user information in the storage unit 120.

In addition, the acquisition unit 131 acquires various history information (log data) representing a behavior of the user U through the communication unit 110. For example, the acquisition unit 131 may acquire various history information representing the behavior of the user U from the terminal apparatus 10 of the user U or from various servers or the like based on the user ID or the like. The acquisition unit 131 stores various history information in the storage unit 120.

In addition, the acquisition unit 131 acquires a click log for the delivered advertisement through the communication unit 110. The acquisition unit 131 stores the click log for the delivered advertisement in the storage unit 120. At this time the acquisition unit 131 may store the click log for the delivered advertisement as a database in the storage unit 120.

### ITP Estimation Model Training Unit 132

The ITP estimation model training unit 132 extracts data regarding ITP that is a tracking prevention function from a click log of a delivered advertisement to generate training data, and trains, with the training data, an ITP missing CV estimation model of estimating a conversion (CV) that is missing without being measured by ITP.

### ITP Missing CV Estimation Unit 133

The ITP missing CV estimation unit 133 estimates, using the ITP missing CV estimation model, the conversion (CV) that is missing without being measured by ITP.

### PB Estimation Model Training Unit 134

Separately from the ITP missing CV estimation model, the PB estimation model training unit 134 determines data regarding private browsing based on a click log of a delivered advertisement to generate training data and trains, with the training data, a PB missing CV estimation model of estimating a conversion (CV) that is missing without being measured by private browsing (PB).

At this time, the PB estimation model training unit 134 makes approximation determination of private browsing (PB) in a specific limited domain.

For example, when an elapsed time after issuing a cookie from a specific limited domain is within a fixed threshold, the PB estimation model training unit 134 approximately determines that private browsing (PB) is used.

The PB estimation model training unit 134 uses private browsing (PB) as an estimation target such that the PB estimation model training unit 134 executes estimation utilizing account information of an advertiser or advertisement information without using user information.

### PB Missing CV Estimation Unit 135

The PB missing CV estimation unit 135 estimates, using the PB missing CV estimation model, the conversion (CV) that is missing without being measured by private browsing (PB).

### Output Processing Unit 136

The output processing unit 136 makes a report or improvement regarding the delivered advertisement based on the missing conversion (CV) estimated by the PB missing CV estimation model. Here, the output processing unit 136 makes a report or improvement regarding the delivered advertisement based on the missing conversions (CV) individually estimated by the ITP missing CV estimation model and the PB missing CV estimation model, respectively.

For example, the output processing unit 136 makes a report based on the missing conversion (CV) estimated by the PB missing CV estimation model, and provides the report to an agency or an advertiser of the delivered advertisement. Here, the output processing unit 136 makes a report regarding the delivered advertisement based on the missing conversions (CV) individually estimated by the ITP missing CV estimation model and the PB missing CV estimation model, respectively, and provides the report to an agency or an advertiser of the delivered advertisement.

Alternatively, the output processing unit 136 executes automatic optimization of the delivered advertisement based on the missing conversion (CV) estimated by the PB missing CV estimation model. Here, the output processing unit 136 executes automatic optimization of the delivered advertisement based on the missing conversions (CV) individually estimated by the ITP missing CV estimation model and the PB missing CV estimation model, respectively. For example, the output processing unit 136 automatically executes a delivery control of an advertisement, a change in settings, or the like based on the missing conversions (CV) individually estimated by the ITP missing CV estimation model and the PB missing CV estimation model, respectively.

The output processing unit 136 includes an interface (I/F), and when the missing conversion (CV) estimated by the ITP missing CV estimation model and the missing conversion (CV) estimated by the PB missing CV estimation model overlap each other, the output processing unit 136 overwrites the missing conversion (CV) estimated by the ITP missing CV estimation model with the missing conversion (CV) estimated by the PB missing CV estimation model.

### 5. Procedure

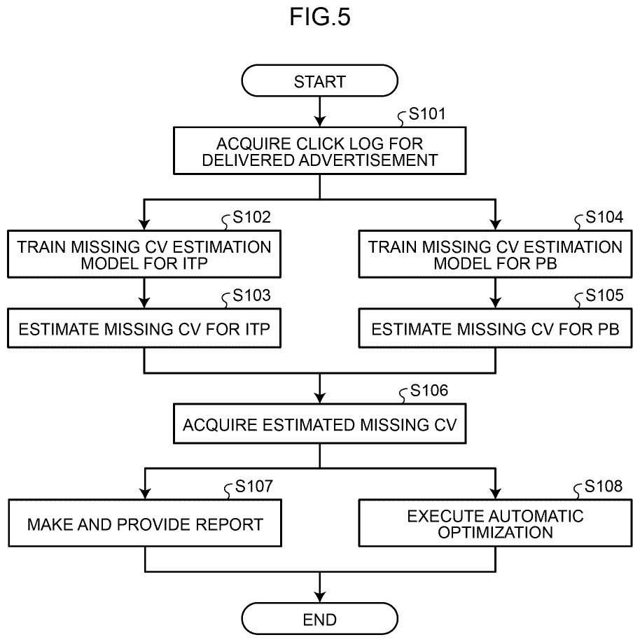

Next, a procedure of the server apparatus 100 according to the embodiment will be described using FIG. 5. FIG. 5 is a flowchart illustrating the procedure according to the embodiment. The procedure described below is repeatedly executed by the control unit 130 of the server apparatus 100.

For example, as illustrated in FIG. 5, the acquisition unit 131 of the server apparatus 100 acquires a click log for a delivered advertisement through communication unit 110 and stores and accumulates the click log in the storage unit 120 (Step S101).

Next, the ITP estimation model training unit 132 of the server apparatus 100 extracts data regarding ITP that is a tracking prevention function from a click log of a delivered advertisement to generate training data, and trains, with the training data, an ITP missing CV estimation model of estimating a conversion (CV) that is missing without being measured by ITP (Step S102).

Next, the ITP missing CV estimation unit 133 of the server apparatus 100 estimates, using the ITP missing CV estimation model, the conversion (CV) that is missing without being measured by ITP (Step S103).

In addition, separately from the ITP missing CV estimation model, the PB estimation model training unit 134 of the server apparatus 100 determines data regarding private browsing based on a click log of a delivered advertisement to generate training data and trains, with the training data, a PB missing CV estimation model of estimating a conversion (CV) that is missing without being measured by private browsing (PB) (Step S104).

Next, the PB missing CV estimation unit 135 of the server apparatus 100 estimates, using the PB missing CV estimation model, the conversion (CV) that is missing without being measured by private browsing (PB) (Step S105).

The processing of Step S102 and Step S103 for ITP and the processing of Step S104 and Step S105 for private browsing (PB) may be executed in parallel, or may be executed at different timings.

Next, the output processing unit 136 of the server apparatus 100 acquires the missing conversions (CV) individually estimated by the ITP missing CV estimation model and the PB missing CV estimation model, respectively, through the interface (I/F) (Step S106). At this time, when the missing conversion (CV) estimated by the ITP missing CV estimation model and the missing conversion (CV) estimated by the PB missing CV estimation model overlap each other, the output processing unit 136 overwrites the missing conversion (CV) estimated by the ITP missing CV estimation model with the missing conversion (CV) estimated by the PB missing CV estimation model.

Next, the output processing unit 136 of the server apparatus 100 makes a report regarding the delivered advertisement based on the missing conversions (CV) individually estimated by the ITP missing CV estimation model and the PB missing CV estimation model, respectively, and provides the report to an agency or an advertiser of the delivered advertisement (Step S107).

Alternatively, the output processing unit 136 of the server apparatus 100 executes automatic optimization of the delivered advertisement based on the missing conversions (CV) individually estimated by the ITP missing CV estimation model and the PB missing CV estimation model, respectively (step S108).

Either or both of the processing of Step S107 and the processing of Step S108 may be executed.

### 6. Modification Example

The terminal apparatus 10 and the server apparatus 100 described above may be implemented in various different forms other than the above-described embodiment. Accordingly, modification examples of the embodiment will be described below.

In the above-described embodiment, some or all of the processes that are executed by the server apparatus 100 may be actually executed by the terminal apparatus 10 (or an application operating on the terminal apparatus 10). For example, the terminal apparatus 10 may execute all the processes stand-alone. In this case, the terminal apparatus 10 may have a function of the server apparatus 100 according to the above-described embodiment. In addition, in the above-described embodiment, the terminal apparatus 10 cooperates with the server apparatus 100. Therefore, when seen from the user U, the processing of the server apparatus 100 looks to be executed by the terminal apparatus 10. That is, from another viewpoint, it can be said that the terminal apparatus 10 includes the server apparatus 100.

In addition, in the above-described embodiment, the server apparatus 100 allows the estimation model to estimate a conversion (CV) that is missing in ITP or PB, but is not limited thereto. For example, the server apparatus 100 may allow the estimation model to estimate the order of conversions (CV) in ITP or PB, or may estimate an engagement without being limited to the conversion (CV).

In addition, in the above-described embodiment, the conversion (CV) estimated by the estimation model may be a direct conversion or an indirect conversion. In addition, the conversion (CV) estimated by the estimation model may be a unique conversion or a total conversion. That is, the type of the conversion is not limited.

In addition, in the above-described embodiment, the server apparatus 100 may estimate a conversion rate (CVR) based on the number of conversions (CV) estimated by the estimation model. That is, the server apparatus 100 may calculate an estimated CVR based on the number of estimated CVs. The server apparatus 100 may make a report or execute automatic optimization based on the estimated CVR.

In addition, in the above-described embodiment, the server apparatus 100 may execute merge sorting of the estimated CV for ITP and the estimated CV for PB.

### 7. Effect

As described above, an information processing apparatus (the terminal apparatus 10 and the server apparatus 100) according to the present application includes: a PB estimation model training unit 134 configured to determine data regarding private browsing based on a click log of a delivered advertisement to generate training data and configured to train, with the training data, a PB missing CV estimation model of estimating a conversion that is missing without being measured by private browsing; a PB missing CV estimation unit 135 configured to estimate, using the PB missing CV estimation model, the conversion that is missing without being measured by private browsing; and an output processing unit 136 configured to make a report or improvement regarding the delivered advertisement based on the missing conversion estimated by the PB missing CV estimation model.

As a result, estimation and complement can be executed on missing of conversion (CV) measurement by private browsing (PB) in a specific browser.

In addition, the information processing apparatus according to the present application further includes: an ITP estimation model training unit 132 configured to extract data regarding ITP that is a tracking prevention function from a click log of a delivered advertisement to generate training data separately from the PB missing CV estimation model and to train, with the training data, an ITP missing CV estimation model of estimating a conversion that is missing without being measured by ITP; and an ITP missing CV estimation unit 133 configured to estimate, using the ITP missing CV estimation model, the conversion that is missing without being measured by ITP. Separately from the ITP missing CV estimation model, the PB estimation model training unit 134 determines data regarding private browsing based on a click log of a delivered advertisement to generate training data and trains, with the training data, a PB missing CV estimation model of estimating a conversion that is missing without being measured by private browsing. The PB missing CV estimation unit 135 estimates, using the PB missing CV estimation model, the conversion that is missing without being measured by private browsing. The output processing unit 136 makes a report or improvement regarding the delivered advertisement based on the missing conversions individually estimated by the ITP missing CV estimation model and the PB missing CV estimation model, respectively.

As a result, assuming that a conversion (CV) is missing 8 days after click in ITP and a CV is missing on the day of click in private browsing (PB), the separate models can be constructed and operated such that: a model of predicting a CV of the eighth day or thereafter where a CV measurement amount or the like for 7 days after click is added to a feature amount is constructed for ITP; and a model of predicting a CV of the first day where a feature amount does not include a CV measurement amount or the like is constructed for PB.

The PB estimation model training unit 134 makes approximation determination of private browsing in a specific limited domain.

As a result, even when whether or not private browsing (PB) is used is unidentifiable from the log, approximation determination can be executed in a limited domain or delivery section of the own company or the like.

When an elapsed time after issuing a cookie from a specific limited domain is within a fixed threshold, the PB estimation model training unit 134 approximately determines that private browsing is used.

As a result, for example, when an elapsed time after issuing a cookie from a specific delivery section of the own company is within a fixed threshold (for example 1 hour), the PB estimation model training unit 134 approximately determines that private browsing is used and executes an examination.

The PB estimation model training unit 134 uses private browsing as an estimation target such that the PB estimation model training unit 134 executes estimation utilizing account information of an advertiser or advertisement information without using user information.

As a result, even when utilization for estimating the user information is difficult, the estimation model internally executes estimation utilizing account information of an advertiser or advertisement information such that private browsing can be estimated.

The output processing unit 136 makes a report regarding the delivered advertisement based on the missing conversions individually estimated by the ITP missing CV estimation model and the PB missing CV estimation model, respectively, and provides the report to an agency or an advertiser of the delivered advertisement.

As a result, to the agency or the advertiser, a CV that is missing in ITP or private browsing (PB) is reported based on the conversion (CV) estimated by the estimation model, and an improvement plan or the like based on the estimated CV can be proposed.

The output processing unit 136 executes automatic optimization of the delivered advertisement based on the missing conversions individually estimated by the ITP missing CV estimation model and the PB missing CV estimation model, respectively.

As a result, a delivery control of an advertisement, a change in settings, or the like can be automatically executed by reflecting a CV that is missing in ITP or private browsing (PB) based on the conversion (CV) estimated by the estimation model.

When the missing conversion estimated by the ITP missing CV estimation model and the missing conversion estimated by the PB missing CV estimation model overlap each other, the output processing unit 136 overwrites the missing conversion estimated by the ITP missing CV estimation model with the missing conversion estimated by the PB missing CV estimation model.

As a result, even when the estimated CV for ITP and the estimated CV for PB overlap each other, a missing CV where the overlap is resolved is reported, and an improvement plan or the like based on the estimated CV can be proposed.

With any one or a combination of the above-described processes, the information processing apparatus according to the present application can execute estimation and complement on missing of conversion measurement in a specific browser.

### 8. Hardware Configuration

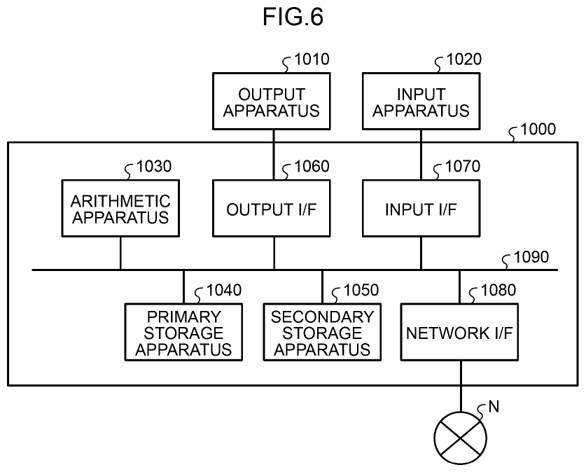

In addition, the terminal apparatus 10 and the server apparatus 100 according to the above-described embodiment are implemented by, for example, a computer 1000 having a configuration illustrated in FIG. 6. Hereinafter, the server apparatus 100 will be described as an example. FIG. 6 is a diagram illustrating an example of a hardware configuration. The computer 1000 is connected to an output apparatus 1010 and an input apparatus 1020, and has a form in which an arithmetic apparatus 1030, a primary storage apparatus 1040, a secondary storage apparatus 1050, an output I/F (Interface) 1060, an input I/F 1070, and a network I/F 1080 are connected through a bus 1090.

The arithmetic apparatus 1030 operates based on a program stored in the primary storage apparatus 1040 or the secondary storage apparatus 1050 or a program read from the input apparatus 1020, or the like to execute various processes. The arithmetic apparatus 1030 is implemented by, for example, a CPU (Central Processing Unit), an MPU (Micro Processing Unit), a GPU (Graphics Processing Unit), an ASIC (Application Specific Integrated Circuit), or an FPGA (Field Programmable Gate Array).

The primary storage apparatus 1040 is a memory apparatus, such as a RAM (Random Access Memory), that temporarily stores data used for various arithmetic operations by the arithmetic apparatus 1030. In addition, the secondary storage apparatus 1050 is a storage apparatus where data or various databases used for various arithmetic operations by the arithmetic apparatus 1030 are registered, and is implemented by a ROM (Read Only Memory), an HDD (Hard Disk Drive), an SSD (Solid State Drive), a flash memory, or the like. The secondary storage apparatus 1050 may be an internal storage or an external storage. In addition, the secondary storage apparatus 1050 may be a removable storage medium such as a USB (Universal Serial Bus) memory or an SD (Secure Digital) memory card. In addition, the secondary storage apparatus 1050 may be a cloud storage (online storage), a NAS (Network Attached Storage), a file server, or the like.

The output I/F 1060 is an interface for transmitting information that is an output target to the output apparatus 1010 such as a display, a projector, or a printer that outputs various information. For example, the output I/F 1060 is implemented by a connector of a standard such as USB (Universal Serial Bus), DVI (Digital Visual Interface), or HDMI (registered trademark) (High Definition Multimedia Interface). In addition, the input I/F 1070 is an interface for receiving information from various input apparatuses 1020 such as a mouse, a keyboard, a keypad, a button, and a scanner, and is implemented by, for example, a USB.

In addition, the output I/F 1060 and the input I/F 1070 may be wirelessly connected to the output apparatus 1010 and the input apparatus 1020, respectively. That is, the output apparatus 1010 and the input apparatus 1020 may be wireless equipment.

In addition, the output apparatus 1010 and the input apparatus 1020 may be integrated equipment such as a touch panel. In this case, the output I/F 1060 and the input I/F 1070 may be integrated as an input/output I/F.

The input apparatus 1020 may be, for example, an apparatus that reads information from an optical recording medium such as CD (Compact Disc), DVD (Digital Versatile Disc), or PD (Phase change rewritable Disk), a magneto-optical recording medium such as MO (Magneto-Optical disk), a tape medium, a magnetic recording medium, a semiconductor memory, or the like.

The network I/F 1080 receives data from another equipment through the network N, transmits the received data to the arithmetic apparatus 1030, and transmits data generated by the arithmetic apparatus 1030 to another equipment through the network N.

The arithmetic apparatus 1030 controls the output apparatus 1010 or the input apparatus 1020 through the output I/F 1060 or the input I/F 1070. For example, the arithmetic apparatus 1030 loads a program from the input apparatus 1020 or the secondary storage apparatus 1050 to the primary storage apparatus 1040, and executes the loaded program.

For example, when the computer 1000 functions as the server apparatus 100, the arithmetic apparatus 1030 of the computer 1000 implements the function of the control unit 130 by executing the program loaded to the primary storage apparatus 1040. In addition, the arithmetic apparatus 1030 of the computer 1000 may load a program acquired from another equipment through the network I/F 1080 to the primary storage apparatus 1040 to execute the loaded program. In addition, the arithmetic apparatus 1030 of the computer 1000 may read a function of a program, data, or the like from another program of another equipment to use the read function, data, or the like in cooperation with the other equipment through the network I/F 1080.

### 9. Others

Hereinabove, the embodiments of the present application have been described, but the present invention is not limited to the contents of these embodiments. In addition, the above-described components can be easily conceived by those skilled in the art, and include substantially the same components, that is, components in a so-called equivalent range. Further, the above-described components can be appropriately combined. Further, various omissions, substitutions, or changes can be made for the components within a range not departing from the scope of the above-described embodiments.

In addition, among the processes described in the above-described embodiments, all or some of the processes that are assumed to be automatically executed in the description can also be manually executed, or all or some of the processes that are assumed to be manually executed in the description can also be automatically executed using a well-known method. In addition, the information including the procedure, the specific names, and various data or parameters described in the above documents or illustrated in the drawings can be freely changed unless otherwise specified. For example, various information illustrated in each of the drawings are not limited to the illustrated information.

In addition, each of the components of each of the apparatuses is functionally conceptual, and does not need to be physically configured as illustrated in the drawings. That is, the specific form of distribution and integration of the apparatuses is not limited to that illustrated in the drawings, and all or some of the apparatuses may be configured to be functionally or physically distributed or integrated in any units according to various loads, usages, and the like.

For example, the above-described server apparatus 100 may also be implemented by a plurality of server computers, and the configuration can be flexibly changed depending on functions, for example, can be implemented by calling an external platform or the like through an API (Application Programming Interface), network computing, or the like.

In addition, the embodiments and the modification examples described above can be appropriately combined within a range where the processing contents are not contradictory to each other.

In addition, “section, module, or unit” described above can be replaced with “means”, “circuit”, or the like. For example, the acquisition unit can be replaced with acquisition means or an acquisition circuit.

According to one aspect of an embodiment, estimation and complement can be executed on missing of conversion measurement in a specific browser.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a PB estimation model training unit configured to determine data regarding private browsing based on a click log of a delivered advertisement to generate training data and configured to train, with the training data, a PB missing CV estimation model of estimating a conversion that is missing without being measured by private browsing;
a PB missing CV estimation unit configured to estimate, using the PB missing CV estimation model, the conversion that is missing without being measured by private browsing; and
an output processing unit configured to make a report or improvement regarding the delivered advertisement based on the missing conversion estimated by the PB missing CV estimation model.

2. The information processing apparatus according to claim 1, further comprising:
an ITP estimation model training unit configured to extract data regarding ITP that is a tracking prevention function from a click log of a delivered advertisement to generate training data separately from the PB missing CV estimation model and to train, with the training data, an ITP missing CV estimation model of estimating a conversion that is missing without being measured by ITP; and
an ITP missing CV estimation unit configured to estimate, using the ITP missing CV estimation model, the conversion that is missing without being measured by ITP,
wherein, separately from the ITP missing CV estimation model, the PB estimation model training unit determines data regarding private browsing based on a click log of a delivered advertisement to generate training data and trains, with the training data, a PB missing CV estimation model of estimating a conversion that is missing without being measured by private browsing,
the PB missing CV estimation unit estimates, using the PB missing CV estimation model, the conversion that is missing without being measured by private browsing, and
the output processing unit makes a report or improvement regarding the delivered advertisement based on the missing conversions individually estimated by the ITP missing CV estimation model and the PB missing CV estimation model, respectively.

3. The information processing apparatus according to claim 1,
wherein the PB estimation model training unit makes approximation determination of private browsing in a specific limited domain.

4. The information processing apparatus according to claim 1,
wherein when an elapsed time after issuing a cookie from a specific limited domain is within a fixed threshold, the PB estimation model training unit approximately determines that private browsing is used.

5. The information processing apparatus according to claim 1,
wherein the PB estimation model training unit uses private browsing as an estimation target such that the PB estimation model training unit executes estimation utilizing account information of an advertiser or advertisement information without using user information.

6. The information processing apparatus according to claim 1,
wherein the output processing unit makes a report based on the missing conversion estimated by the PB missing CV estimation model, and provides the report to an agency or an advertiser of the delivered advertisement.

7. The information processing apparatus according to claim 1,
wherein the output processing unit executes automatic optimization of the delivered advertisement based on the missing conversion estimated by the PB missing CV estimation model.

8. The information processing apparatus according to claim 2,
wherein when the missing conversion estimated by the ITP missing CV estimation model and the missing conversion estimated by the PB missing CV estimation model overlap each other, the output processing unit overwrites the missing conversion estimated by the ITP missing CV estimation model with the missing conversion estimated by the PB missing CV estimation model.

9. An information processing method that is executed by an information processing apparatus, the method comprising:
a PB estimation model training process of determining data regarding private browsing based on a click log of a delivered advertisement to generate training data and training, with the training data, a PB missing CV estimation model of estimating a conversion that is missing without being measured by private browsing;
a PB missing CV estimation process of estimating, using the PB missing CV estimation model, the conversion that is missing without being measured by private browsing; and
an output processing process of making a report or improvement regarding the delivered advertisement based on the missing conversion estimated by the PB missing CV estimation model.

10. A non-transitory computer readable storage medium storing an information processing program causing a computer to execute:
a PB estimation model training procedure of determining data regarding private browsing based on a click log of a delivered advertisement to generate training data and training, with the training data, a PB missing CV estimation model of estimating a conversion that is missing without being measured by private browsing;
a PB missing CV estimation procedure of estimating, using the PB missing CV estimation model, the conversion that is missing without being measured by private browsing; and
an output processing procedure of making a report or improvement regarding the delivered advertisement based on the missing conversion estimated by the PB missing CV estimation model.
